(19) United States
(12) Patent Application Publication
(10) Pub. No.: US 2018/0194024 A1
(43) Pub. Date: Jul. 12, 2018

(54) ELECTRIC HANDHELD HAIR TRIMMER AND METHOD OF OPERATING THE SAME

(71) Applicant: Spectrum Brands, Inc., Middleton, WI (US)

(72) Inventors: Daniel R. Teteak, Madison, WI (US); Seung IL Kim, Madison, WI (US); Timin Ahmad Musallam, Sun Prairie, WI (US); Paul Allen Schmitt, Madison, WI (US); David Yet Toy, Madison, WI (US); Alex Rosandick, Madison, WI (US); Cale Yerigan, Verona, WI (US)

(21) Appl. No.: 15/869,422

(22) Filed: Jan. 12, 2018

Related U.S. Application Data
(60) Provisional application No. 62/445,358, filed on Jan. 12, 2017.

(51) Int. Cl. B26B 19/38; B26B 19/06; B26B 19/28

(52) U.S. Cl. CPC B26B 19/3886; B26B 19/06; B26B 19/284; B26B 19/3846; B26B 19/386

(57) ABSTRACT

In an electric handheld hair trimmer and method of operating the same, at least one of a first blade and a second blade of a blade assembly is operatively connected to a motor for driven movement in a working direction. An actuator is movable relative to the housing and operatively connected to at least one of the first blade and the second blade. The actuator is operable independent of the motor to move the at least one of the first blade and the second blade in one of: a) the working direction, b) a direction other than the working direction and to an extent that the first and second blades are rendered inoperable for trimming hair, c) a direction in which the first and second blades are separated from each other, and d) combinations thereof.

### CROSS-REFERENCE TO RELATED APPLICATIONS

This application claims priority to U.S. Provisional Application No. 62/445,358 filed on Jan. 12, 2017, which is incorporated herein by reference in its entirety.

### BACKGROUND

The present invention relates generally to grooming appliances, more particularly to electric handheld hair trimmers and even more particularly to electric handheld hair trimmers used for trimming ear and nose hair.

Conventional electric hair trimmers typically include a blade housing that supports a blade assembly used for trimming hair. In at least some hair trimmers, the blade assembly includes at least one reciprocating blade and a motor operable to reciprocate the at least one reciprocating blade relative to a second—typically stationary—blade. Following repeated use of the hair trimmer, the reciprocating blade movement may be inhibited by the build-up of hair particles, debris and/or bodily fluids such as oils, mucus or ear wax which may collect between the blades of the blade assembly, or in the drive elements that drive reciprocation of the at least one reciprocating blade. This can be particularly prevalent when the trimmer is turned on after it has been idle during non-use. Some trimmers, such as cordless trimmers, may not have enough power to overcome the resistance to the blade movement caused by this build-up. As such, it would be useful to provide a hair trimmer that is capable of overcoming such resistance to blade movement and may further facilitate the removal of debris from the blade housing and/or the blade assembly.

### SUMMARY

In one embodiment, an electric handheld hair trimmer generally comprises a housing, a motor disposed in the housing, and a blade assembly disposed at least in part exterior of the housing and including a first blade and a second blade. At least one of the first blade and the second blade is operatively connected to the motor for driven movement in a working direction relative to the other one of the first blade and the second blade. An actuator is movable relative to the housing and operatively connected to at least one of the first blade and the second blade. The actuator is operable independent of the motor to move the at least one of the first blade and the second blade relative to the other one of the first blade and the second blade in one of: a) the working direction, b) a direction other than the working direction and to an extent that the first and second blades are rendered inoperable for trimming hair, c) a direction in which the first and second blades are separated from each other, and d) combinations thereof.

In another embodiment, an electric handheld hair trimmer generally comprises a housing, a motor disposed in the housing and operable between an ON state and an OFF state, and a blade assembly disposed at least in part exterior of the housing and including a first blade and a second blade in sliding contact with each other. At least one of the first blade and the second blade is operatively connected to the motor for driven movement of the at least one of the first blade and the second blade relative to the other one of the first blade and the second blade. A separator is operable independently of the motor and is positionable between the first blade and the second blade to at least in part separate the first blade from the second blade.

In one embodiment of a method of operating an electric handheld hair trimmer, the motor is operated in an ON state to slidably move at least one of the first blade and second blade in a working direction relative to the other one of the first blade and second blade to trim hair. Independently of the operation of the motor, at least one of the first blade and the second blade is moved relative to the other one of the first blade and the second blade in one of: a) the working direction, b) a direction other than the working direction and to an extent that the first and second blades are rendered inoperable for trimming hair, c) a direction in which the first and second blades are separated from each other, and d) combinations thereof.

### BRIEF DESCRIPTION

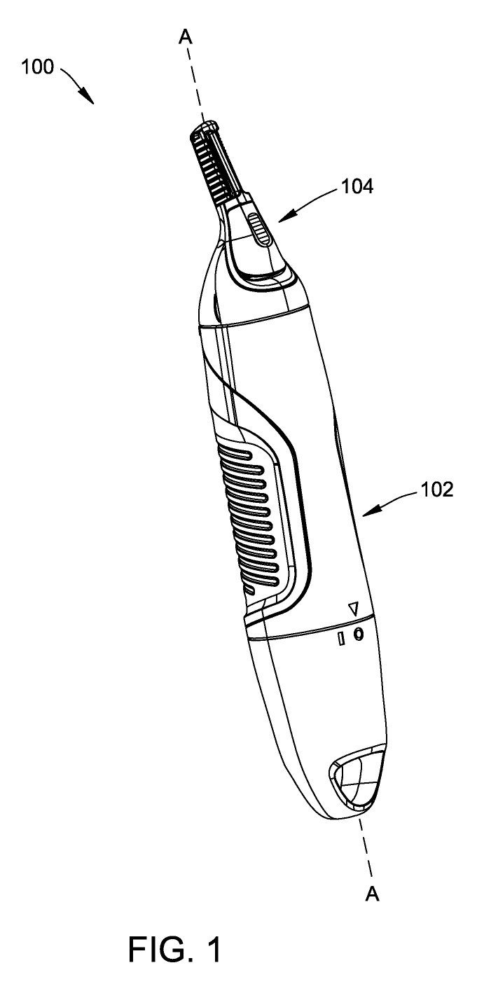

FIG. 1 is a perspective view of one embodiment of an electric hair trimmer.

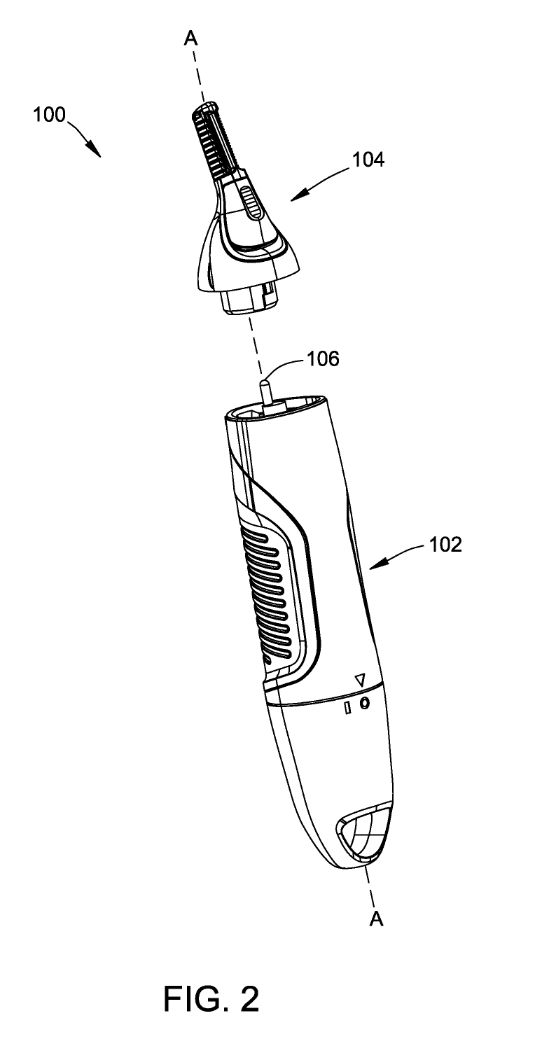

FIG. 2 is a partially exploded view of the trimmer of FIG. 1.

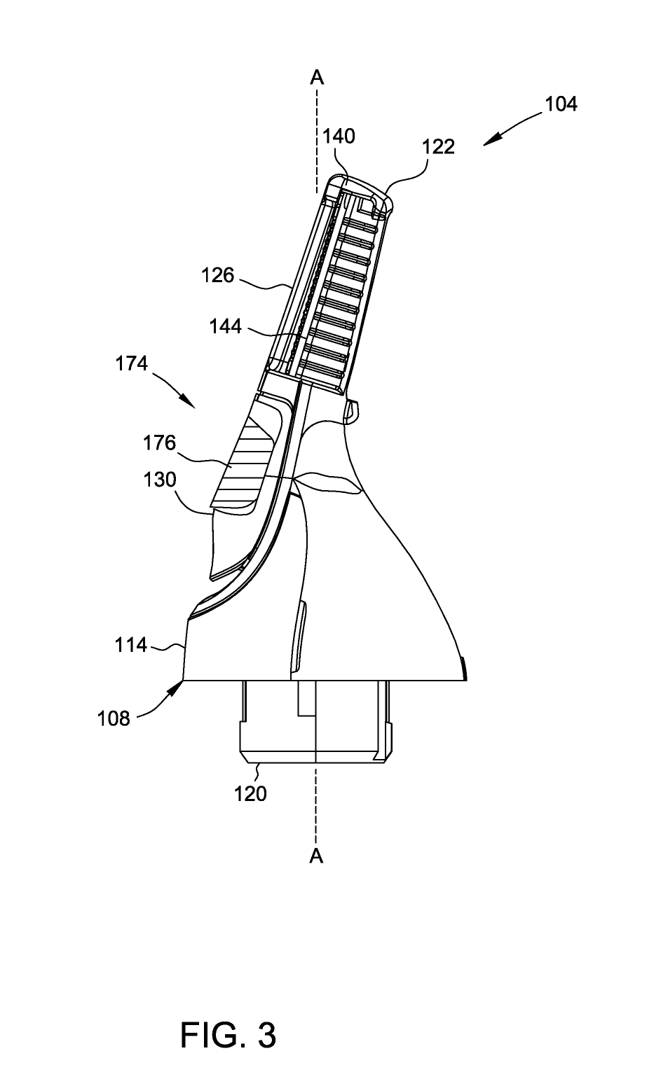

FIG. 3 is a side view of a head of the trimmer of FIG. 1.

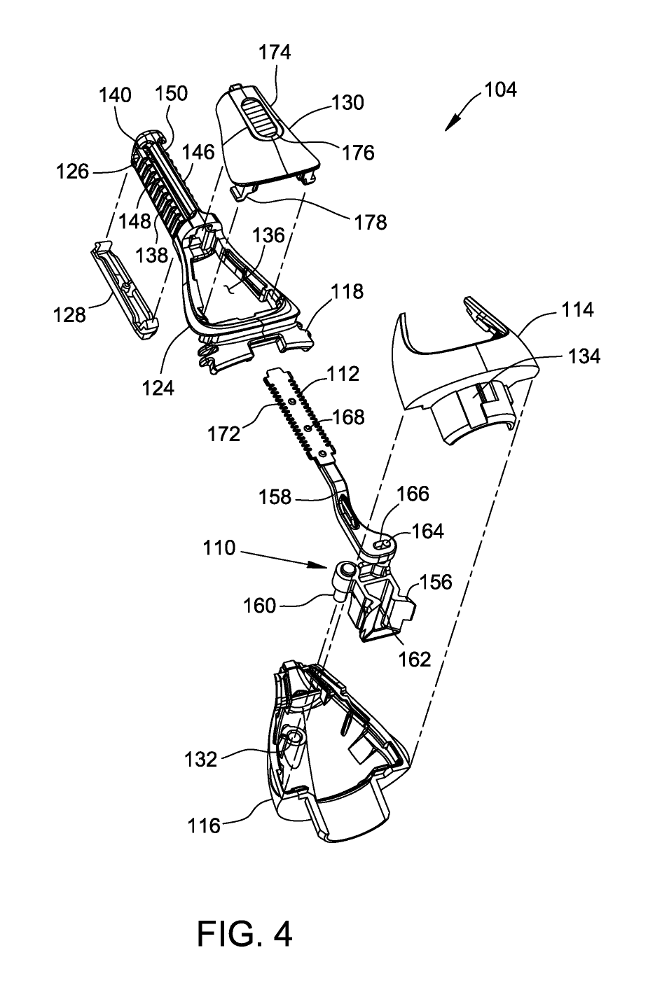

FIG. 4 is an exploded view of the head of FIG. 3.

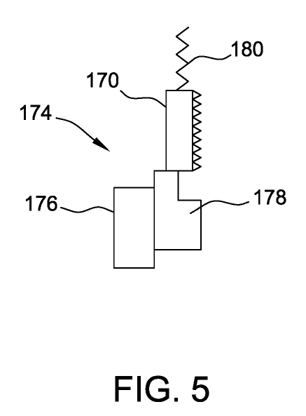

FIG. 5 is a schematic view of an actuator mechanism of the trimmer of FIG. 1.

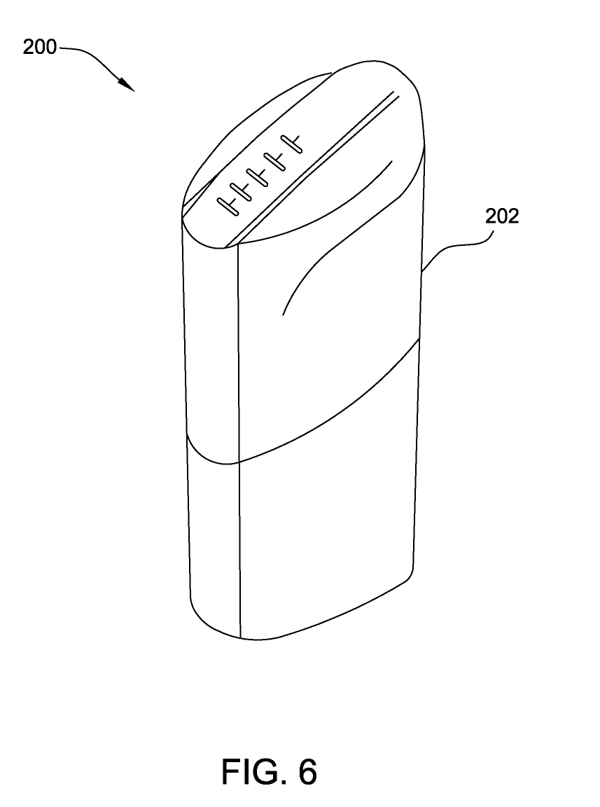

FIG. 6 is a perspective view of another embodiment of an electric hair trimmer, with the trimmer illustrated in a closed configuration.

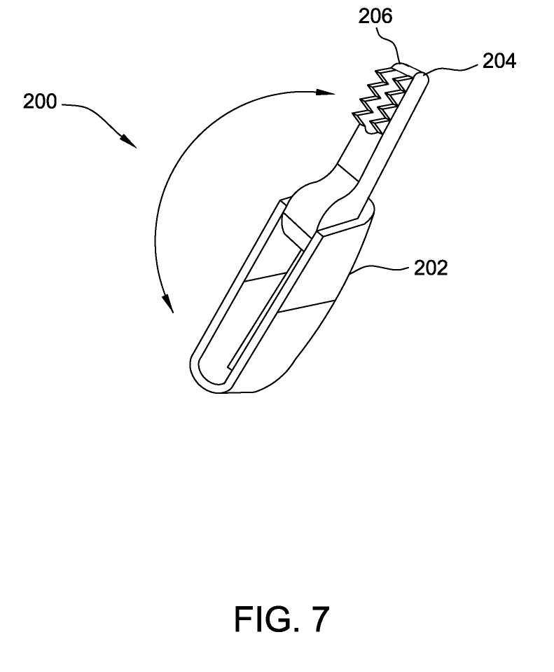

FIG. 7 is a perspective view of the trimmer of FIG. 6 in an opened configuration.

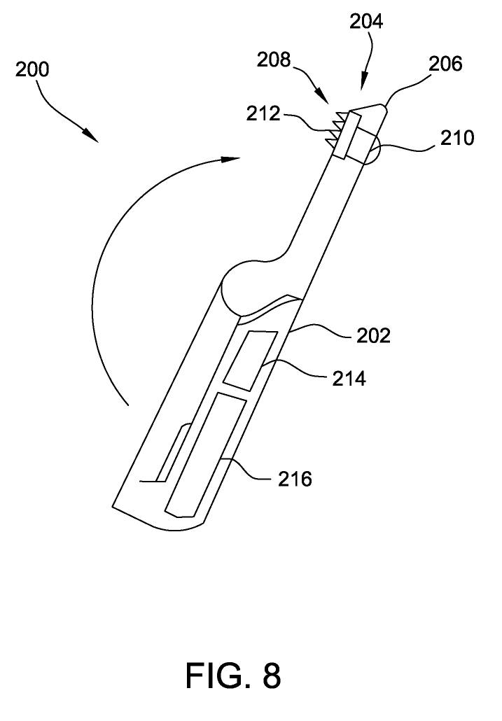

FIG. 8 is a cross-sectional view of the trimmer of FIGS. 6 and 7.

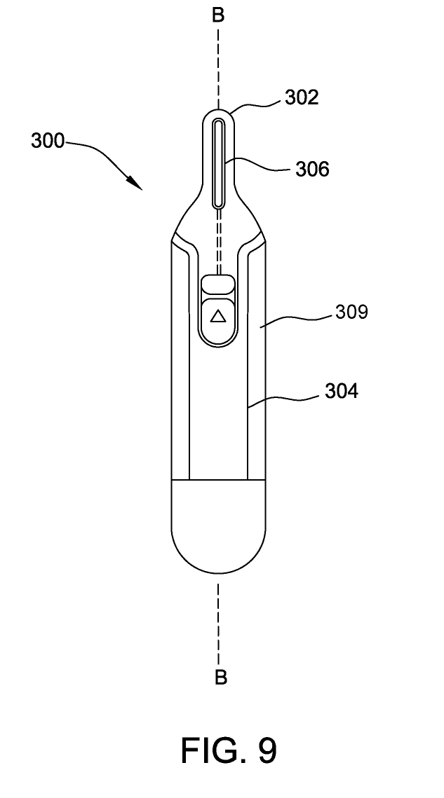

FIG. 9 is a front view of another embodiment of an electric hair trimmer.

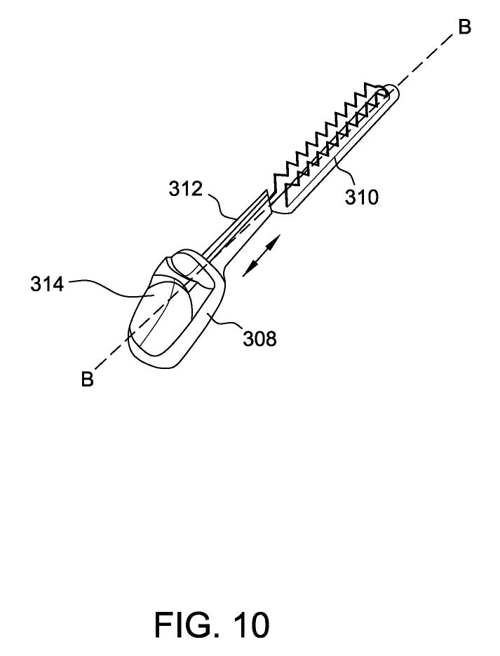

FIG. 10 is a schematic view of an actuator of the trimmer of FIG. 9.

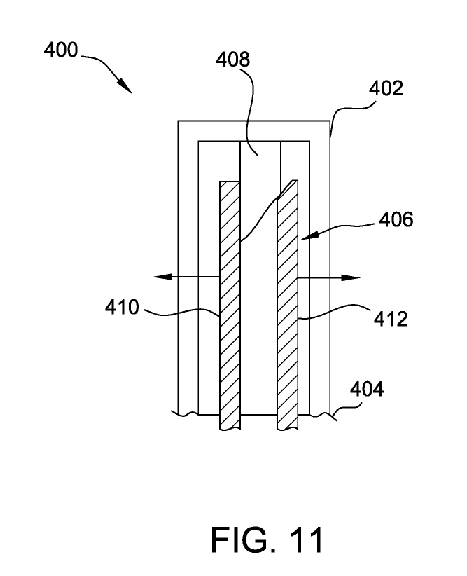

FIG. 11 is a schematic view of a portion of another trimmer including a cap for covering a blade assembly of the trimmer during non-use.

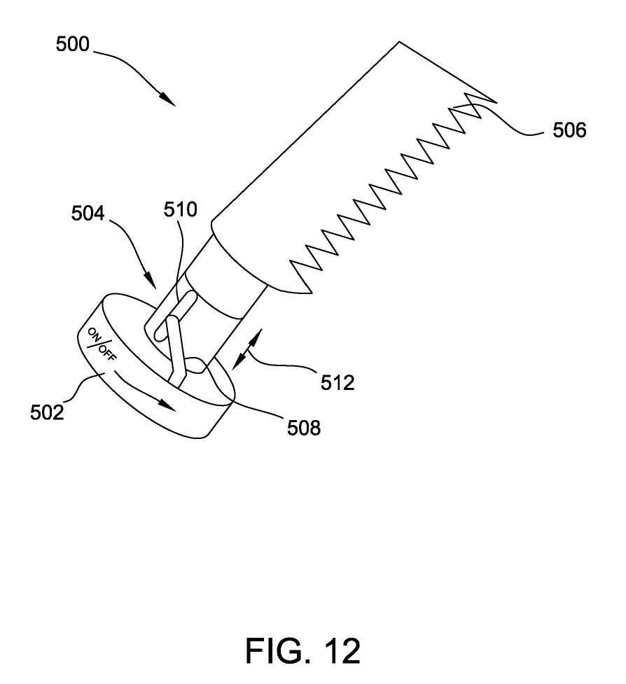

FIG. 12 is a schematic view of a portion of another embodiment of a trimmer including a switch.

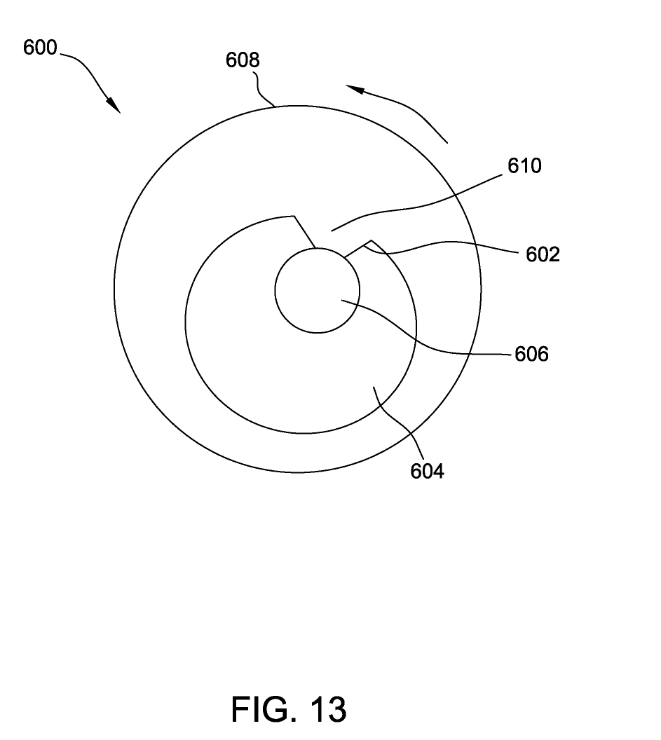

FIG. 13 is a schematic view of a portion of another embodiment of a trimmer including a cam and cam follower.

Corresponding reference characters indicate corresponding parts throughout the several views of the drawings.

### DETAILED DESCRIPTION

In the following specification and the claims, reference will be made to a number of terms, which shall be defined to have the following meanings. The singular forms “a,” “an,” and “the” include plural references unless the context clearly dictates otherwise. The terms “comprising,” “including,” and “having” are intended to be inclusive and mean that there may be additional elements other than the listed elements. “Optional” or “optionally” means that the subsequently described event or circumstance may or may not occur, and that the description includes instances where the event occurs and instances where it does not.

Referring now to the drawings, and in particular to FIGS. 1 and 2, an electric handheld hair trimmer (broadly a handheld grooming appliance) is indicated generally by 100. The hair trimmer 100 of the illustrated embodiment is in the form of a nose and ear hair trimmer. However, it is understood that the hair trimmer 100 may be other than for trimming nose and ear hair and remain within the scope of this invention. It is also understood that the concepts disclosed herein may be used in other electric handheld grooming appliances that have moving components susceptible to poor performance resulting from debris, such as without limitation, rotary shavers, foil shavers, hair clippers and epilators. The illustrated hair trimmer 100 comprises a handle (indicated generally by 102) and a head (indicated generally by 104) together generally defining a longitudinal axis A-A of the trimmer. A motor (not shown) is disposed in the handle and is operatively connected to the head 104 by a suitable drive mechanism (e.g., an eccentric drive pin 106) such that the trimmer 100 has a longitudinal axis A-A. Other suitable drive mechanisms are contemplated to be within the scope of the present invention. In the illustrated embodiment, the head 104 is detachable from the handle 102. However, the head 104 may be affixed to handle 102 within the scope of the invention.

With reference now to FIGS. 3 and 4, the head 104 includes a housing (indicated generally by 108), a drive assembly (indicated generally by 110), a blade assembly 112, and an actuator 174. The drive assembly 110, and part of the blade assembly 112, are contained within the housing 108 such that cutting edge(s) of the blade assembly 112 are exposed for trimming hair. The actuator 174 is connected to the blade assembly 112 and allows an operator to manually reciprocate the blade assembly 112 relative to the housing 108. As a result, the actuator 174 enables the operator to dislodge debris that may collect on the blade assembly 112 and within the housing 108.

The housing 108 includes a front shell 114, a back shell 116 connected to the front shell 114, and a frame 118 extending longitudinally outward from between the shells 114, 116—the assembly of which defines a proximal end 120 and a distal end 122 of the head 104. The frame 118 has a base segment 124 secured between the shells 114, 116, a guard segment 126 extending from the base segment 124, a back panel 128 connected to the guard segment 126, and a front panel 130 connected to the base segment 124.

A pivot post 132 having a central bore therein is formed on the interior of the back shell 116. A keyway 134 is formed on the exterior of the front shell 114 for use in releasably connecting the head 104 to the handle 102 (shown in FIG. 1) of the trimmer 100. The base segment 124 is generally horseshoe-shaped and defines a window 136, and the guard segment 126 includes a pair of spaced-apart side walls 138 and an end wall 140. The side walls 138 extend from the base segment 124, and the end wall 140 extends between the side walls 138 opposite the base segment 124 such that the side walls 138 and the end wall 140 surround the blade assembly 112. Moreover, a back opening (not shown) and a front opening 144 provide access to the interior of the guard segment 126 as set forth in more detail below. The front opening 144 is bifurcated into a first blade slot 146 and a second blade slot 148 by a rib 150 that extends between the end wall 140 and the base segment 124.

The drive assembly 110 and the blade assembly 112 are mounted within the housing 108 of the head 104. The drive assembly 110 includes a follower 156, a linkage 158, and a pivot pin 160. The pivot pin 160 is received in the central bore of the pivot post 132 to pivotally connect the drive assembly 110 to the housing 108. The follower 156 has a winged slot 162 and a linking pin 164, and is pivotable about the pivot pin 160. The linkage 158 is a generally linear arm having, at opposing ends of the arm, a linking slot 166 and a plurality of locator pins 168. The linking slot 166 receives the linking pin 164 of the follower 156, and the winged slot 162 of the follower 156 receives the drive pin 106 of the handle 102.

With reference to FIGS. 2-4, during operation of the trimmer 100, the eccentric drive pin 106 is rotated (e.g., via a drive shaft of a motor contained within the handle 102), and the follower 156 pivots back-and-forth (in a pendulum-like manner) about the pivot pin 160 by virtue of the rotating eccentric drive pin 106 being disposed within the winged slot 162 of the follower 156. Because the linking pin 164 of the follower 156 is inserted into the linking slot 166 of the linkage 158, the back-and-forth pivoting movement of the follower 156 about the pivot pin 160 causes a back-and-forth linear movement (or translatory motion) of the linkage 158. In the illustrated embodiment, the blade assembly 112 includes a first or stationary blade 170 (shown in FIG. 5) and a second or reciprocating blade 172. The blades 170, 172 are arranged in shearing, face-to-face contact with one another, and at least one of the blades is seated on the locator pins 168 of the linkage 158. In the illustrated embodiment, for example, the reciprocating blade 172 is operatively connected to the motor by the linkage 158 such that the reciprocating blade 172 is reciprocated relative to the first or stationary blade 170 in what is referred to herein as a working direction of the reciprocating blade to trim hair upon operation of the motor.

With the blade assembly 112 (e.g., a movable blade of the blade assembly 112) being seated on the linkage 158 via the locator pins 168, the blade assembly 112 is actuated by the linear movement of the linkage 158, thereby reciprocating the blade 172 in the working direction thereof relative to the stationary blade 170 to shear off hairs that enter the gaps between the respective teeth of the blades. In the illustrated embodiment, the blades 170, 172 of the blade assembly 112 extend longitudinally of the housing 108, e.g., generally parallel to the longitudinal axis A-A to provide a relative long, narrow profile of the blade assembly for ease of positioning the blade assembly in a user's nose or ear. In alternative embodiments, the blade assembly 112 may have a horizontal profile relative to the longitudinal axis of the housing, or any other suitable blade orientation that enables the trimmer 100 to operate as described herein.

With reference to FIG. 5, the actuator 174 includes a slide 176 and an engagement arm 178. The arm 178 extends from the slide 176 and engages the stationary blade 170 such that movement of the slide 176 causes a displacement of the stationary blade 170. In particular, the actuator 174 causes displacement of the stationary blade 170 from a first, normal position to a second, displaced position independent of the motor—i.e., there is no operative connection of the stationary blade 170 with the motor. A portion of the slide 176 extends on the exterior of the housing 108 (shown in FIG. 4) and is accessible by an operator. To operate the actuator 174, an operator contacts the slide 176 and moves the slide 176 longitudinally along the housing 108. The movement of the slide 176 causes displacement of the stationary blade 170 relative to the reciprocating blade 172 (shown in FIG. 4) and the housing 108 (shown in FIG. 4) in a direction parallel to the longitudinal axis A-A. In alternative embodiments, the actuator 174 may be any suitable actuator that enables the trimmer 100 to operate as described herein.

As shown in FIG. 5, the trimmer 100 further includes a biasing member 180 that extends between the housing 108 and the stationary blade 170. The biasing member 180 suitably biases the stationary blade 170 toward its normal position such that actuation by the actuator 174 displaces the stationary blade against the bias of the biasing member to the displaced position of the stationary blade. In this manner, once the actuator 174 is released the stationary blade 170 shifts back to its normal position. In the illustrated embodiment, the biasing member 180 is a helical compression spring. In alternative embodiments, the trimmer 100 may include any biasing member that enables the trimmer 100 to operate as described herein. In further embodiments, the biasing member 180 may be omitted and the actuator must be used to shift the stationary blade 170 back to its normal position.

In the illustrated embodiment, the biasing member 180 contacts an end of the stationary blade 170 opposite the actuator 174 to bias the stationary blade 170 towards the normal position. In alternative embodiments, the biasing member 180 may bias the first blade 170 toward its displaced position. While in the illustrated embodiment the actuator 174 is used to operatively displace the stationary blade 170 relative to the reciprocating blade 172, it is understood that in other embodiment an actuator—such as actuator 174 or a separate, discrete actuator (not shown) may be used to operatively displace the reciprocating blade 172 relative to the stationary blade 170.

With reference to FIGS. 3-5, during operation of the trimmer 100, hair and other debris may collect in the housing 108 and on the blade assembly 112. To clean the trimmer 100, a user may direct a cleaning fluid (e.g., a liquid such as water or a suitable cleaning solution in the primary embodiment, or a compressed gas in other embodiments) into contact with the blade assembly 112. In some embodiments, for example, the trimmer 100 may include a washout port and a flow passage (not shown) for fluid to flow through the head 104 to clean the blade assembly 112 and interior of the housing 108. In other embodiments, the trimmer 100 may be cleaned in any manner that enables the trimmer 100 to operate as described herein.

During cleaning of the trimmer 100, e.g., when the motor is off such that the reciprocating blade 172 is not moving, the operator may use the actuator 174 to displace the stationary blade 170 relative to the reciprocating blade 172 to dislodge debris around and between the blades. This operation may also be done by the user just prior to using the trimmer 100 after the trimmer has been idle. Because the stationary blade 170 can move independently of the motor, it can be displaced by the actuator 174 relative to the reciprocating blade 172 while the motor is off (i.e., while the reciprocating blade is not moving). In some embodiments, the trimmer 100 may be turned on and automatically cause the actuator 174 to briefly displace the stationary blade 170 just prior to or concurrently with initiating reciprocation of the reciprocating blade 172 to dislodge any debris obstructing reciprocation of the blade assembly 112 as operation is initiated.

With reference to FIGS. 6-8, another embodiment of an electric hair trimmer is indicated generally by 200. Trimmer 200 includes a body 202 and a head assembly 204 movably (e.g., in the illustrated embodiment, pivotably) coupled to the body 202 such that the trimmer 200 can be configured between an opened configuration (shown in FIG. 7) for operation of the trimmer and a closed configuration (shown in FIG. 6) for storage of the trimmer. When the trimmer 200 is in the opened configuration, the head assembly 204 extends from the body 202. In the closed configuration, the head assembly 204 is at least partially stowed within the body 202. In suitable embodiments, the head assembly 204 and the body 202 may be configured in any manner that enables the trimmer 200 to operate as described herein. While in the illustrated embodiment the head assembly 204 is pivotably connected to the body 202, in other embodiments the head assembly 204 may move linearly along a longitudinal axis of the body 202.

With reference to FIG. 8, the head assembly 204 includes a housing 206, a blade assembly 208, and an actuator 210. A part of the blade assembly 208 is contained within the housing 206 and cutting edge(s) of the blade assembly 208 are exposed for trimming hair. The actuator 210 is coupled to the blade assembly 208 such that the actuator 210 causes at least one blade 212 of the blade assembly 208 to move. The actuator 210 is accessible from exterior of the housing 206 to enable an operator to manipulate the actuator 210. In the illustrated embodiment, the actuator 210 is configured to move linearly when an operator applies a force to the actuator 210. Movement of the actuator 210 causes the blade 212 (e.g., the stationary blade in a manner similar to the stationary blade 170 of the embodiment of FIGS. 1-5) of the blade assembly 208 to displace along a longitudinal axis of the blade assembly 208. In other embodiments, the trimmer 200 may include any actuator that enables the trimmer 200 to operate as described herein. For example, in some embodiments, the actuator 210 may cause the blade 212 to displace in response to the trimmer 200 being reconfigured between the opened configuration and the closed configuration.

The trimmer 200 further includes a motor 214 and a power source 216. The motor 214 and the power source 216 are housed within the body 202. The motor 214 is connected to the power source 216 and to the blade assembly 208. During operation of the trimmer 200, the motor 214 is powered by the power source 216 and causes the blade assembly 208 to reciprocate for trimming hairs. In the illustrated embodiment, the trimmer 200 includes an internal power source 216 such as a battery. In other embodiments, the trimmer 200 may include any power source that enables the trimmer 200 to operate as described herein. For example, in some embodiments, the trimmer 200 may be configured to receive power from an external power source. In such embodiments, the trimmer 200 may include a power cord.

In one example, the actuator 210 is configured to move the stationary blade of the blade assembly 208 independently of the motor 214. As a result, the actuator 210 facilitates unjamming the blade assembly 208 if the motor 214 is unable to adequately reciprocate the blade assembly 208. In some embodiments, the actuator 210 may be used during operation of the motor 214. In other embodiments, the actuator 210 may be connected to the motor 214 and operable only when the motor 214 is in a designated state, such as when the motor is off.

FIGS. 9 and 10 illustrate another electric hair trimmer 300 of the present invention in which the trimmer includes a head 302, a handle 304, a blade assembly 306, and an actuator 308. The head 302 includes a housing 309 at least partially supporting the blade assembly 306. The blade assembly 306 is configured such that at least one of the blades reciprocates relative to the other blade along a longitudinal axis B-B of the trimmer 300.

With reference to FIG. 10, the actuator 308 is configured to engage at least one blade, such as the stationary blade 310 of the blade assembly 306, to linearly (e.g., longitudinally) displace the stationary blade 310 relative to the reciprocating blade. In other embodiments, the blade 310 may be moved in any direction relative to the reciprocating blade that enables the trimmer 300 to operate as described herein.

In the illustrated embodiments, the actuator 308 includes an engagement arm 312 and a slide 314. The slide 314 may be exposed exterior of the housing 309 opposite the blade assembly 306 to allow an operator to operate the actuator 308. The slide 314 is configured to move along the longitudinal axis B-B when an operator applies a displacement force to the slide 314. When the slide 314 is moved, the engagement arm 312 moves therewith to displace the blade 310 in response to movement of the slide. As a result, the force applied to the slide 314 is directly transferred to the blade 310. In alternative embodiments, the actuator 308 may have any configuration that enables the trimmer 300 to operate as described herein.

With reference to FIG. 11, in another embodiment a hair trimmer 400 further includes a cap 402 along with a housing 404 and blade assembly 406. The cap 402 is positionable relative to the housing 404 and may be releasably connectable to the housing 404 such that the cap 402 at least partially covers and encloses the blade assembly 406 during non-use of the trimmer. In some embodiments, the cap 402 may remain at least partially connected to the housing 404 when the blade assembly 406 is uncovered for operation of the trimmer. For example, in some embodiments, the cap 402 may be connected to the housing 404 by a suitable hinge.

In the illustrated embodiment, the cap 402 is configured such that when placed on the housing 404 the blade assembly 406 extends at least in part within an interior space of the cap. With reference to FIG. 11, a separator 408 is connected to the cap 402 (e.g., by being formed integrally therewith or by being suitably affixed or releasably connected thereto) to extend into the interior space of the cap. In particular, in the illustrated embodiment, the separator 408 extends from the closed end of the cap 402 towards the open end. In other embodiments, the separator 408 may be positioned anywhere on the cap 402. For example, in some embodiments, the separator 408 may extend from a sidewall of the cap 402.

The separator 408 is configured to be inserted in part between the stationary blade 410 and the reciprocating blade 412 of the blade assembly 406 when the cap 402 is connected to the housing 404 and covers the blade assembly 406. As a result, the separator 408 separates the blades 410, 412 from each other when the cap 402 is positioned on the housing 404. The positioning of the blades 410, 412 by the separator 408 inhibits the blade assembly 406 becoming jammed with debris or otherwise stuck together as a result of debris during non-use of the trimmer. When the cap 402 is removed from the housing 108, the blades 410, 412 are biased back into closely spaced or contacting relationship with each other for normal operation of the trimmer to trim hair. In alternative embodiments, the separator 408 may be configured to displace the stationary blade 410 and/or the reciprocating blade 412 relative to each other in a manner other than spacing them apart in order to inhibit the blades from becoming jammed with debris or otherwise stuck together during non-use.

In alternative embodiments, the separator 408 may be connected to components other than the cap 402. For example, in some embodiments, the separator 408 may extend from the housing 404 and be configured to displace the stationary blade 410 and/or the reciprocating blade 412. In some embodiments, the blades 410, 412 may be displaced automatically when the operating state of the trimmer 400 is switched and/or when the cap 402 is moved (e.g., placed on the housing and/or removed from the housing). In further embodiments, an actuator, such as the actuators 174, 210, and 308 described above, is disposed on at least one of the housing 404 and blade assembly and is operatively connected to the separator 408 to selectively position the separator between the stationary blade 410 and the reciprocating blade 412.

FIG. 12 is a schematic view of a portion of another trimmer 500 including a switch 502—in this embodiment a rotatory switch. The trimmer 500 further includes an actuator 504 and a blade assembly 506. The switch 502 is configured to control power to a motor (not shown) of the trimmer 500. The motor is configured to operate the blade assembly 506 to trim hair when the switch is in an ON position. When the switch 502 is in an OFF position, power to the motor ceases and the blade assembly is inoperable to trim hair. In other embodiments, the switch 502 may include a toggle, a slide, a button, a joystick, a proximity switch, an optical switch, a speed switch, a pressure switch, a temperature switch, and/or any other suitable switch.

The actuator 504 includes an arm 508 and a body 510 connected to a proximal end of the arm 508. A distal end of the arm 508 is positioned adjacent the switch 502. The switch 502 is configured to contact the arm 508 when the switch 502 moves between the ON position and the OFF position. When the switch 502 contacts the arm 508, the switch 502 causes the arm 508 to be displaced in a longitudinal direction C-C and the body 510 to move in the longitudinal direction C-C. Accordingly, the actuator 504 translates rotational motion of the switch 502 to linear displacement of the body 510 and hence displacement of at least one of the blades of the blade assembly 506 independent of the motor (e.g., when the motor is off).

In suitable embodiments, the switch 502 may contact the actuator 504 when the switch is in a position intermediate the ON position and the OFF position. Accordingly, the actuator 504 may be displaced as the switch 502 is moved from the OFF position toward the ON position. In such embodiments, the actuator 504 may provide an initial movement of the blade assembly 506, i.e., a kickstart, prior to or simultaneous with the motor reciprocating the blade assembly 506 in order to overcome any resistance to such initial movement of the blades resulting from a build-up of debris or otherwise sticking together.

FIG. 13 is a schematic view of a portion of another trimmer 600. This trimmer 600 includes a cam 602, an eccentric drive 604, an actuator 606, and a switch 608. The switch 608 is used to control operating states of the trimmer 600. In particular, the switch 608 is positionable between an ON position and an OFF position. When the switch 608 is in the ON position, a blade assembly (not shown) of the trimmer 600 is operated to trim hairs. The switch 608 engages the eccentric drive 604 to switch operating modes of the trimmer 600. In alternative embodiments, the trimmer 600 may include any switch 608 that enables the trimmer 600 to operate as described herein.

In the illustrated embodiment, a cam follower 610 extends into the cam 602. As the switch 608 moves between the ON and OFF positions, the cam follower 610 moves along the cam 602 and causes the actuator 606 to move. In the illustrated embodiment, the cam 602 includes an angled groove such that rotational movement of the switch 608 is translated by the cam follower 610 into axial (e.g., linear) movement of the actuator 606. In alternative embodiments, the trimmer 600 may include any cam 602 and cam follower 610 that enables the trimmer 600 to operate as described herein.

In the illustrated embodiment, the cam follower 610 disengages from the cam 602 once the switch 608 has reached a designated point in its rotation. As a result, the actuator 606 allows the eccentric drive 604 to connect to the blade assembly and operate the blade assembly during normal operation of the trimmer to trim hair without interference by the actuator 606. Such a configuration allows the actuator 606 to move the same blade that is reciprocated by the eccentric drive 604 without the actuator 606 interfering with subsequent operation of the eccentric drive 604. In alternative embodiments, the actuator 606 may be instead be engaged with the stationary blade of the blade assembly during any operating state of the trimmer 600.

As described above, embodiments of a trimmer include an actuator that is configured to move a blade of the trimmer independently of a motor. The actuator may move the blade to remove debris that may inhibit operation of the trimmer. Also, the actuator allows an operator to manually move the blade, e.g., to provide a kickstart, when the motor is unable to reciprocate the blade. As a result, the described embodiments reduce jamming of the trimmer blades. In some embodiments, the actuator allows an operator to manually move the blade. In further embodiments, the actuator may automatically move the blade in response to initiating operation of the trimmer and/or upon ceasing operation of the trimmer.

Exemplary embodiments of an apparatus, system, and methods for a grooming device are described above in detail. The apparatus, system, and methods described herein are not limited to the specific embodiments described, but rather, components of apparatus, systems, and/or steps of the methods may be utilized independently and separately from other components and/or steps described herein. For example, the methods may also be used in combination with other grooming devices, systems, and methods, and are not limited to practice with only the apparatuses, systems, and methods described herein. Rather, the exemplary embodiments can be implemented and utilized in connection with many grooming applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As various changes could be made in the above embodiments without departing from the scope of the disclosure, it is intended that all matter contained in the above description and shown in the accompanying drawings shall be interpreted as illustrative and not in a limiting sense.

What is claimed is:

1. An electric handheld hair trimmer comprising:
a housing,
a motor disposed in the housing;
a blade assembly disposed at least in part exterior of the housing and including a first blade and a second blade, at least one of the first blade and the second blade being operatively connected to the motor for driven movement in a working direction relative to the other one of the first blade and the second blade; and
an actuator movable relative to the housing and operatively connected to at least one of the first blade and the second blade, the actuator being operable independent of the motor to move the at least one of the first blade and the second blade relative to the other one of the first blade and the second blade in one of: a) the working direction, b) a direction other than the working direction and to an extent that the first and second blades are rendered inoperable for trimming hair, c) a direction in which the first and second blades are separated from each other, and d) combinations thereof.

2. The hair trimmer of claim 1 wherein the motor is operatively connected to the first blade for driving movement of the first blade relative to the second blade in the working direction, the actuator being operatively connected to the second blade to selectively move the second blade relative to the first blade independent of operation of the motor.

3. The hair trimmer of claim 2 wherein the second blade is moveable by the actuator relative to the first blade between a first position in which the blade assembly is operable by the motor to trim hair and a second position in which the blade assembly is inoperable by the motor to trim hair, the second blade being biased toward said first position.

4. The hair trimmer of claim 1 wherein the motor is operatively connected to the first blade for driving movement of the first blade relative to the second blade in the working direction, the actuator being operatively connected to the first blade to selectively move the first blade relative to the second blade when the motor is off.

5. The hair trimmer of claim 4 wherein the motor is also operatively connected to the second blade for driving movement of the second blade relative to the first blade in the working direction.

6. The hair trimmer of claim 1 further comprising a switch operatively connected to the motor for selectively switching the motor between an ON state and an OFF state, the actuator being responsive to the switch being used to switch the motor from its ON state to its OFF state to move the at least one of the first blade and second blade relative to the other one of the first blade and the second blade.

7. The hair trimmer of claim 1 further comprising a switch operatively connected to the motor for selectively switching the motor between an ON state and an OFF state, the actuator being responsive to the switch being used to switch the motor from its OFF state to its ON state to move the at least one of the first blade and second blade relative to the other one of the first blade and the second blade.

8. The hair trimmer of claim 1 further comprising a switch operatively connected to the motor for selectively switching the motor between an ON state and an OFF state, the actuator being operable to move the at least one of the first blade and second blade relative to the other one of the first blade and the second blade when the switch is in its ON state.

9. The hair trimmer of claim 1 wherein the housing has a longitudinal axis, the actuator comprising a slide disposed on the exterior of the housing and slidably moveable relative thereto in operative connection with the at least one of the first blade and the second blade.

10. The hair trimmer of claim 9 wherein the slide is slidably moveable in a direction generally parallel to the working direction of the at least one of the first blade and the second blade.

11. The hair trimmer of claim 9 wherein the blade assembly extends longitudinally of the housing, at least one of the first blade and the second blade being movable by the actuator longitudinally of the housing.

12. The hair trimmer of claim 1 wherein the housing has a longitudinal axis, the actuator comprising a rotational actuator rotatable relative to the housing in operative connection with the at least one of the first blade and the second blade.

13. An electric handheld hair trimmer comprising:
a housing,
a motor disposed in the housing and operable between an ON state and an OFF state;
a blade assembly disposed at least in part exterior of the housing and including a first blade and a second blade in sliding contact with each other, at least one of the first blade and the second blade being operatively connected to the motor for driven movement of the at least one of the first blade and the second blade relative to the other one of the first blade and the second blade; and
a separator operable independently of the motor and being positionable between the first blade and the second blade to at least in part separate the first blade from the second blade.

14. The hair trimmer of claim 13 further comprising an actuator disposed on at least one of the housing and blade assembly and being positionable relative thereto, the actuator being operatively connected to the separator to selectively position the separator between the first blade and the second blade.

15. The hair trimmer of claim 13 further comprising an actuator operatively connected to the separator to position the separator between the first blade and the second blade, the actuator being responsive to the motor being one of: switched from its ON state to its OFF state and switched from its OFF state to its ON state to position the separator between the first blade and the second blade.

16. The hair trimmer of claim 13 further comprising a cap, the cap being configured for at least one of: sliding movement relative to the housing and releasable connection to the housing to at least partially cover the blade assembly, the separator being connected to the cap for positioning between the first and second blade upon said at least one of sliding movement relative to the housing and releasable connection to the housing to at least partially cover the blade assembly.

17. The hair trimmer of claim 13 wherein the first blade and the second blade are biased into sliding contact with each other such that when the separator is positioned other than between the first blade and the second blade, the first blade and the second blade are urged into sliding contact with each other.

18. A method of operating an electric handheld hair trimmer, the hair trimmer comprising a blade assembly including a first blade and a second blade in sliding contact with each other, at least one of the first blade and the second blade being operatively connected to a motor for driven movement in a working direction relative to the other one of the first blade and the second blade, the method comprising:
operating the motor in an ON state to slidably move the at least one of the first blade and second blade relative to the other one of the first blade and second blade in the working direction to trim hair; and
independently of the operation of the motor, moving at least one of the first blade and the second blade relative to the other one of the first blade and the second blade in one of: a) the working direction, b) a direction other than the working direction and to an extent that the first and second blades are rendered inoperable for trimming hair, c) a direction in which the first and second blades are separated from each other, and d) combinations thereof.

19. The method of claim 18 further comprising the step of switching the motor to an OFF state to cease sliding movement of the at least one of the first blade and the second blade in the working direction relative to the other one of the first blade and the second blade prior to independently moving at least one of the first blade and the second blade relative to the other one of the first blade and the second blade in one of: a) the working direction, b) a direction other than the working direction and to an extent that the first and second blades are rendered inoperable for trimming hair, c) a direction in which the first and second blades are separated from each other, and d) combinations thereof.

20. The method of claim 18 wherein the step of moving at least one of the first blade and the second blade relative to the other one of the first blade and the second blade independently of the motor is conducted manually by a user of the hair trimmer.

21. The method of claim 18 wherein the step of moving at least one of the first blade and the second blade relative to the other one of the first blade and the second blade independently of the motor is conducted automatically by the hair trimmer in response to the motor being switched at least one of: from the ON state to the OFF state and from the OFF state to the ON state.
